(19) United States
(12) Patent Application Publication
(10) Pub. No.: US 2018/0104139 A1
(43) Pub. Date: Apr. 19, 2018

(54) Muscle Massage Device With Fixed and Adjustable Forearm Support

(71) Applicant: Evan Scott Guy, Magnolia, TX (US)

(72) Inventor: Evan Scott Guy, Magnolia, TX (US)

(21) Appl. No.: 15/294,548

(22) Filed: Oct. 14, 2016

(51) Int. Cl. A61H 15/00

(52) U.S. Cl. CPC A61H 15/0092; A61H 2015/0014

(57) ABSTRACT

The first embodiment of a handheld personal muscle massage device has an arm rest that reacts the compressive massage force against the forearm to allow higher massage forces than would otherwise be possible. Additionally, the roller is extended from the location of the hand to facilitate massage of areas of the lower leg without the person having to bend over to administer massage effort. The second embodiment has the same attributes as the first embodiment, with the added attribute of an adjustable angle between the two structural frameworks to allow massage access to body areas that are not accessible by the device of the first embodiment. Additionally, the device of the second embodiment folds into itself for compact storage.

### CROSS-REFERENCE TO RELATED APPLICATIONS

This application claims the benefit of provisional patent application Ser. No. 62/241,450 filed 2015 Oct. 14 by the present inventor.

### BACKGROUND—Prior Art

The following is a tabulation of some prior art that presently appears relevant:

U.S. Patents

| Pat. No. | Issue Date | Patentee |
|---|---|---|
| US4989585A | 1991 Feb. 5 | Auker |
| US20140114221A1 | 2014 Apr. 24 | Indermill |
| US20060155225A1 | 2006 Jul. 13 | Murdock |

Active people often encounter sore muscles after periods of muscular exertion. Massaging muscles by kneading the muscle tissue in the direction parallel to the length of the muscle is effective in loosening up tightness and restoring blood flow to the internal tissue.

“Rolling” has been popular for a long time and seems to be effective. This entails applying a rolling load to the muscle, in the direction of the muscle's length. Rolling is accomplished in two ways. A person can use a two-handed roller, which resembles a baker's “rolling pin” (used for rolling dough into thin sections), and apply force to the muscle while rolling it back-and-forth with a reciprocating motion. Indermill's device operates under this premise. The second method of rolling muscles involves the use of a cylindrical piece of foam polymer or similar material (approx, 6 inch diameter and 1.5-2 feet in length), aptly called a “foam roller” that is placed on the ground. The person then positions their body over the foam roller and uses their arms and legs to support most of their body weight, but allowing some of the body weight to exert force upon the foam roller. The foam roller is positioned beneath the muscle that is being targeted for this rolling therapy. The person then rocks back-and-forth in a reciprocating movement over the affected sore muscle being treated. The foam roller moves along the muscle length as is rolls in a reciprocating motion along the ground.

Foam rollers and the two-handed “rolling pin” type rollers are currently popular and available at specialty running and triathlete retail stores, sporting goods stores, and online via the internet. Foam rollers are effective above the knee for upper leg, gluteus, and lower back regions. Their use below the knee for massaging lower leg regions is less effective due to reduced load on the muscles. When rolling above the knee, there is the moment provided by the weight of lower leg that counters the weight of the torso. Achieving sufficient load on the muscles above the knee is not a problem. When rolling below the knee, it is difficult to achieve loading of the muscle sufficient to provide satisfactory displacement of the muscle tissue to provide remedy. Foam rolling below the knee is less effective than rolling above the knee.

Two-handed rollers can exert effective loads above and below the knee when the subject is standing. These require both hands to grip opposing ends in order to operate the device. If massage below the knee is sought, the person must bend over and reach downward in order to administer this self-massage. This is at least uncomfortable, and at most could cause back strain due to the ‘slumped over’ posture required to administer below-the-knee muscle massage using a two-handed roller.

Foam rollers and two-handed rollers each have their unique disadvantages. Foam rollers are less effective in rolling tissue below the knee than above the knee. Foam rollers also require that the subject person lies horizontally on the ground. Two-handed rollers have compromised posture in order to massage areas below the knee. The detracting features of these devices do lead to people negating the use of these therapeutic devices due to the inconvenience of using these devices. This is contrary to the effort of releasing tight muscles in order to continue to advance in athletic ability, or relieving tight muscles to regain normal lifestyle.

The devices of both Auker and Murdock show devices held in one hand. Lacking a forearm rest or other load-reacting feature, the massage load is carried solely by the wrist. This may result in lower massage force due to insufficient strength of the wrist to provide the needed force. Also, the short length of the device requires the person to bend over to administer massage to the lower legs. The two-handed device of Indermill also requires the person to bend over to massage areas below the knee. Additionally, the Indermill device can not be used to massage arms or areas near the arms, as both hands are involved in the action of the device.

### SUMMARY

In accordance with one embodiment a handheld personal massage device comprises a handle, forearm rest, fixed rotatable roller, and mounting structure for massaging muscle tissue.

### ADVANTAGES

Accordingly, the embodiments presented exhibit advantages over prior art. These embodiments allow massage of both above-the-knee and below-the-knee with a similar deep tissue effect, while standing. Additionally, this device can provide muscle rolling to many areas of the body, including muscles of and near the opposing arm. This device is held in one hand and has a reactive member that acts against the forearm to effect higher force at the massage location. The roller location is extended from the hand position to allow ease of reaching areas below the knee without requiring the person to bend over.

### DRAWINGS—Figures

FIG. 1 shows the assembly of the first embodiment, non-adjustable

FIG. 2 shows the assembly of the second embodiment, adjustable

FIG. 3 shows the assembly of the first embodiment constructed with round material

FIG. 4 shows the method of holding the assembly of the first embodiment

FIG. 5 shows the assembly of the first embodiment being used to massage calf muscle

FIG. 6 shows the assembly of the second embodiment being used to massage upper arm muscle

FIG. 7 shows a section view of the first embodiment

FIG. 8 shows an enlarged view of the roller and bearing interface, common to first and second embodiments

FIG. 9 shows an enlarged view of the handle and side plate interface of the first embodiment

FIG. 10 shows section view of the second embodiment

FIG. 11 shows an enlarged view of the hinge clamping area of the second embodiment

FIG. 12 shows details of the inner coupling and inner side plate of the second embodiment

FIG. 13 shows details of the outer coupling and outer side plate of the second embodiment

FIG. 14 shows a section view of the inner and outer couplings of the second embodiment

FIG. 15 shows the angled assembly of the second embodiment

FIG. 16 shows the folded assembly of the second embodiment

FIG. 17 shows a variety of roller styles that can be used with both the first and second embodiments

### DRAWINGS—REFERENCE NUMERALS

27 first embodiment, tubing assembly
28 first embodiment, flat side plates assembly
29 second embodiment, flat side plates assembly
30 crowned roller
31 handle
32 forearm rest
33 side plate
34 tubing frame structure
35 inner side plate
36 outer side plate
37 barrel nut
38 screw flange
39 clamping knob
40 threaded connector
41 bearing for roller
42 long barrel nut
43 inner coupling
44 steel ball
45 outer coupling

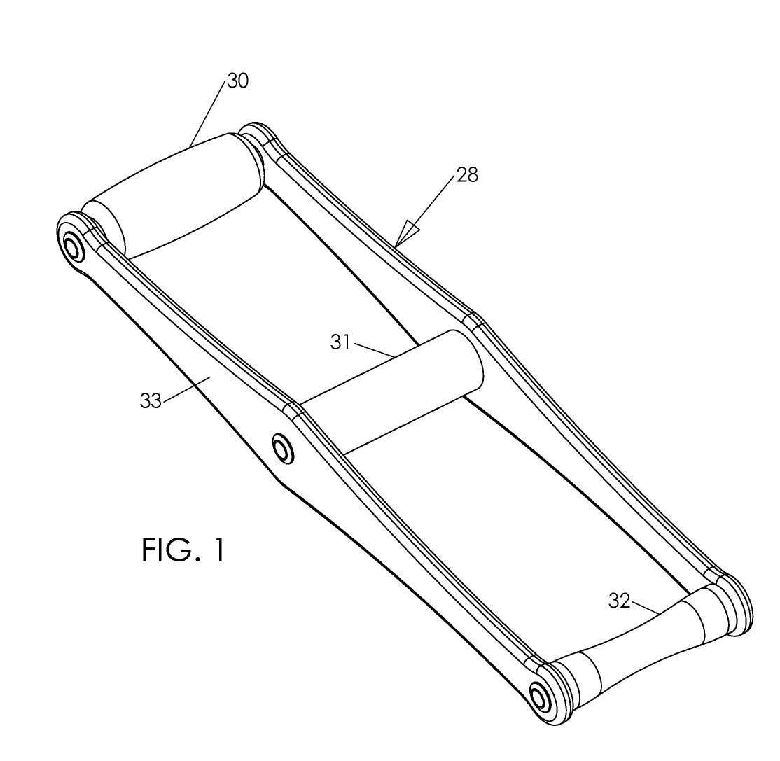

### Detailed Description—FIGS. 1,3,4,5,7, and 10—First Embodiment

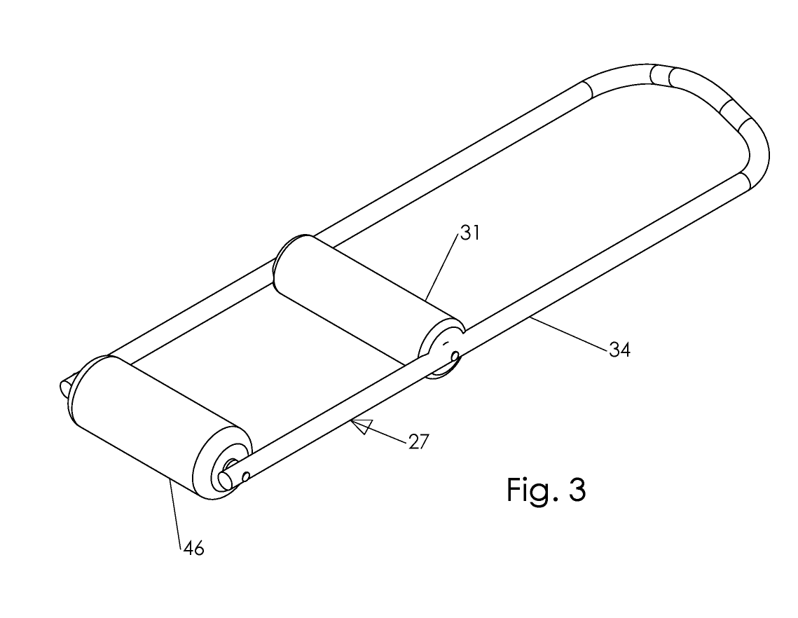

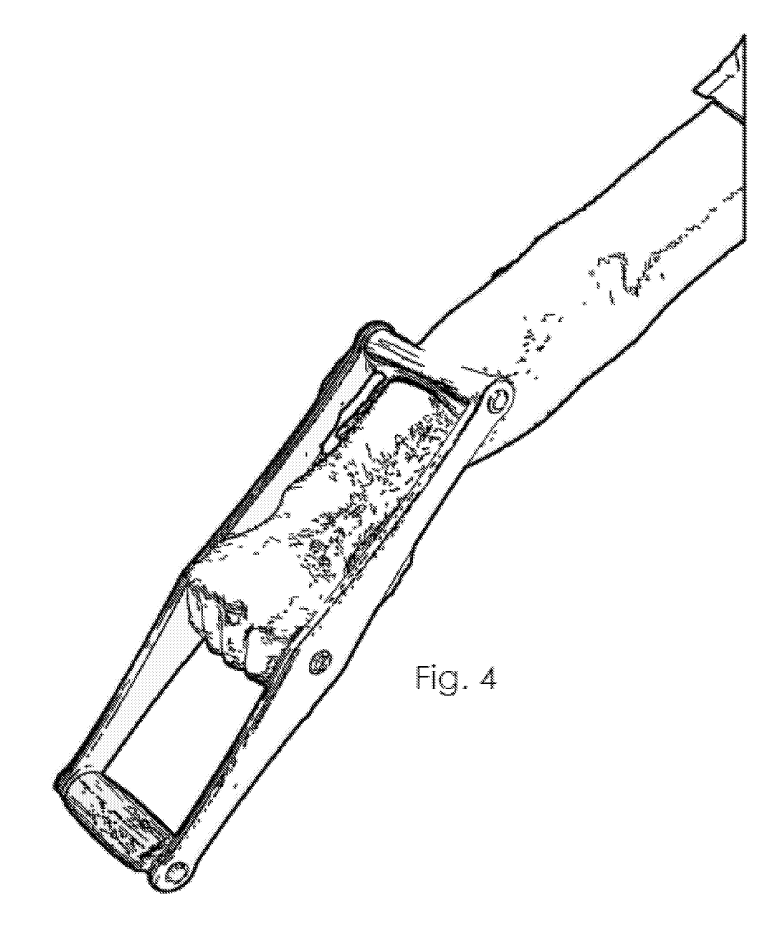

The first embodiment of the massage device is shown in FIG. 1. The assembly 28 is handheld by moving the hand between the two side plates 33 and grasping handle 31. The concave curvature of arm rest 32 bears against the person's forearm. FIG. 4 shows how the person holds the device. The handle 31 and arm rest 32 are fixed and do not rotate relative to the side plates 33. The roller 30 has mounted bearings, either plain or rolling element, to allow rotation if so urged.

The first embodiment features a singular structural framework constructed with two flat side plates 33 as seen in FIG. 1, or alternatively with bar stock or tubing 34 frame structure as shown in FIG. 3 In this case, the tubing has been formed with curvature where it is to bear against the forearm.

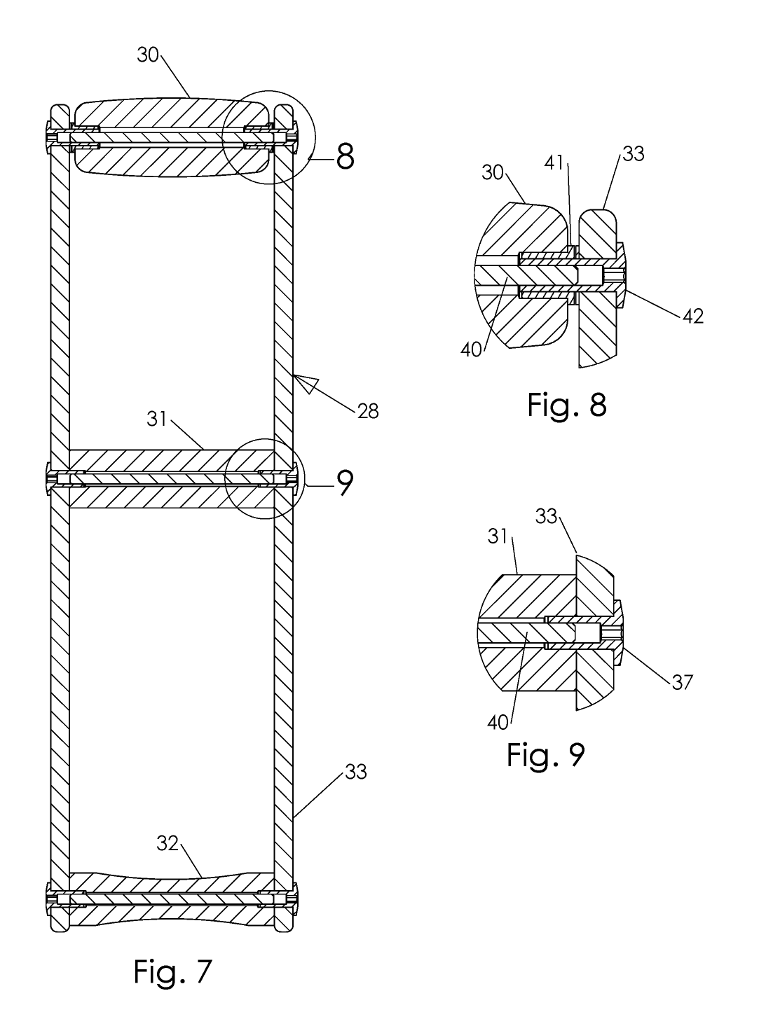

FIG. 7 shows a section view of the first embodiment, assembly 28. FIG. 8 is an enlarged section view of the roller and side plate area. In this design example, the flanged plain bearing 41 is pressed into the cylindrical bore of roller 30. The long barrel nut 42 is installed through the hole in side plate 33 and threaded onto threaded connector 40. When the roller 30 is urged to rotate, relative motion occurs between bearing 41 and long barrel nut 42.

FIG. 9 is an enlarged section view of the connection between the handle and side plate. This connection is the same as the connection of the arm rest to the side plate. Barrel nut 37 fits firmly into the hole in side plate 33 and the cylindrical bore of handle 31. Barrel nut 37 is threaded onto threaded connector 40 and tightened to effect axial clamping of both side plates 33 to the handle 31.

FIG. 10 shows different roller styles that can be used with either the first or second embodiments. Roller 46 is cylindrical with no grooving features. Roller 47 is cylindrical with radial grooves. Roller 48 is cylindrical with radial and axial grooves. Roller 30 is barrel shaped with no grooves. Roller 49 is barrel shaped with radial grooves and Roller 50 is barrel shaped with both radial and axial grooves. Barrel shaping and grooving increase the contact loading of the muscle for a given applied load. For a given applied load, Roller 46 produces the lowest contact stress on the muscle tissue, while Roller 50 produces the highest. A person with tight muscles that require a lot of massage force might prefer the more aggressive attributes of Roller 50.

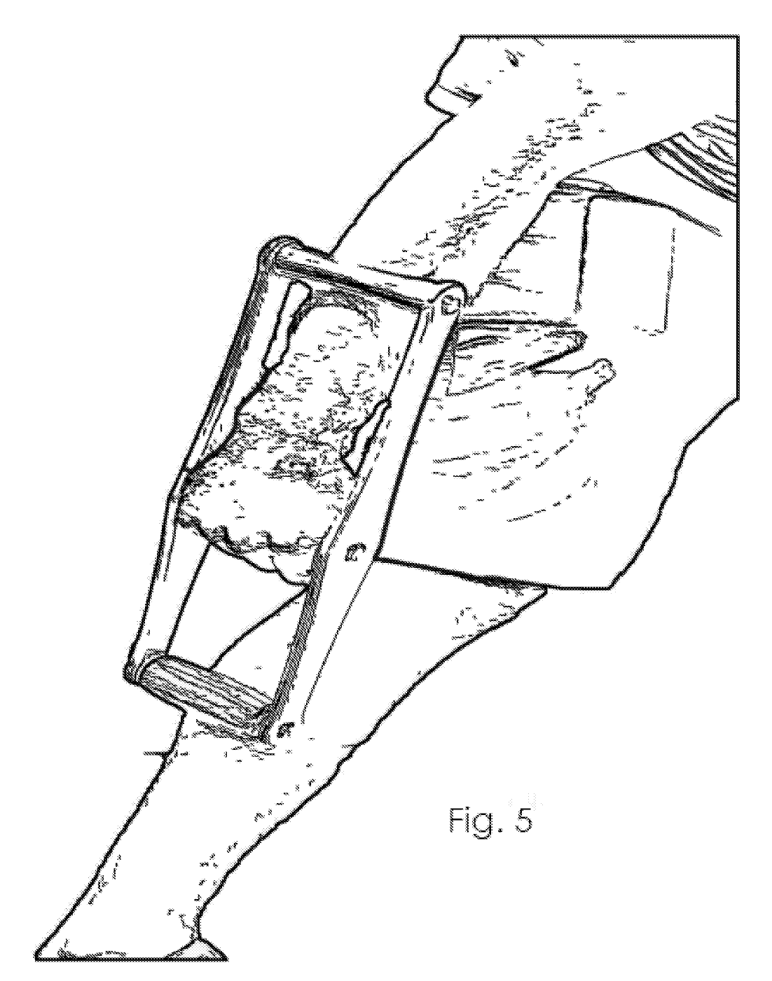

### Operational Description—FIGS. 4 and 5—First Embodiment

FIG. 4 shows the assembly of the first embodiment and how the user would hold the device. This device has arm rest 32 that is fastened to side plates 33. Arm rest 32 bears against the forearm and allows the user to exert more force to the massage effort than would be possible without the this force reaction attribute. Also, note that the roller is extended from the hand. This allows massage of leg areas below the knee while standing, without the user bending over.

FIG. 5 shows the assembly of the first embodiment being used to massage the calf muscle on the back of the leg. The arm is moved in a nearly vertical reciprocating path to effect massage of the long calf muscle parallel to its orientation. The muscles of the arm and shoulder apply force to the device while the massaging process is occurring to impart force along with the stroking action.

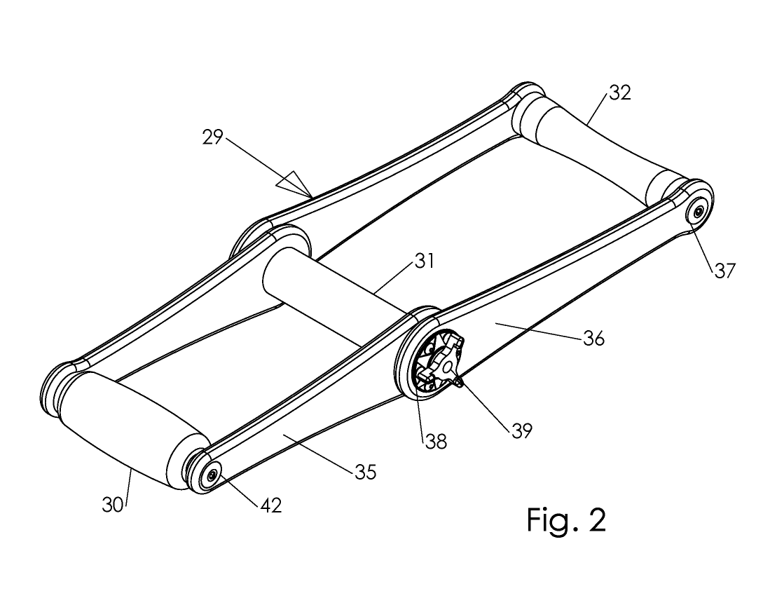

### Detailed Description—FIGS. 2,8, and 9—Second Embodiment

The second embodiment of the massage device is shown in FIG. 2. The assembly 29 is handheld by moving the hand between the two outer side plates 36 and grasping handle 31. The concave curvature of arm rest 32 bears against the person's forearm. This second embodiment has and additional feature that is not present in the first embodiment. The second embodiment features two structural frameworks, with a pivotal hinge feature connecting the two. The first structural framework is formed by the assembly of two inner side plates 35, roller 30, and handle 31. The second framework is formed by the assembly of two outer side plates 36 and the arm rest 32. These two structural frameworks are pivotally connected coaxial to the handle 31.

FIG. 10 shows a section view of the second embodiment, flat side plates assembly 29. The details of the roller end and arm rest end are the same as those of the first embodiment. The difference lies in the dual structural framework and the pivotal connection of these frameworks.

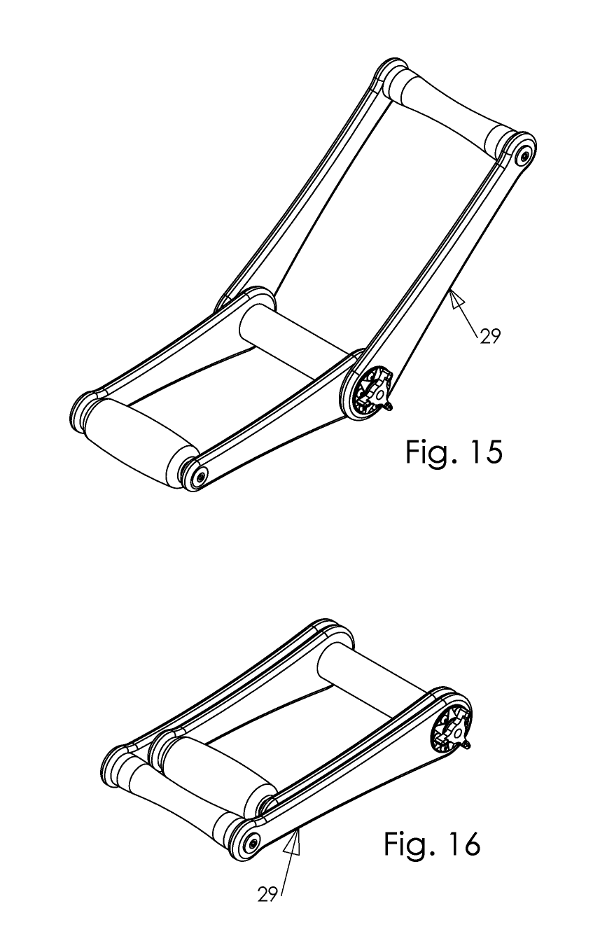

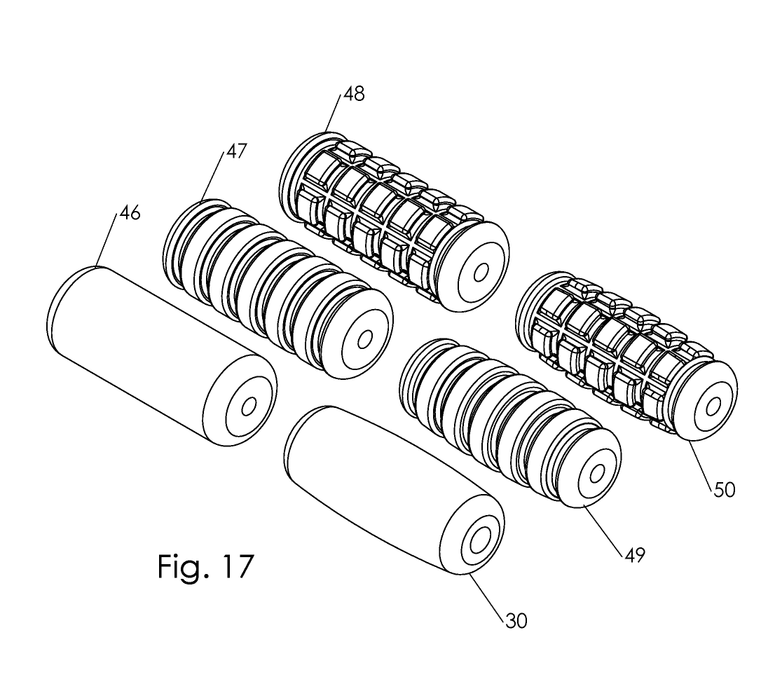

FIG. 11 is an enlarged section view of the pivotal connection. Inner coupling 43 is a component that is pressed into a machined cavity of the inner side plate 35. It has a plurality of holes, into which are pressed hardened steel balls 44. Outer coupling 45 is pressed into the machined cavity of the outer side plate 36. Outer coupling 45 has many shallow holes of smaller diameter than the balls 44. This arrangement forms a lockable detent feature. When clamping knob 39 is loosened, the frameworks can be pivotally rotated with respect to each other, resulting in an angled relationship that is apparent in FIG. 15. Tightening clamping knob 39 locks the assembly rigidly.

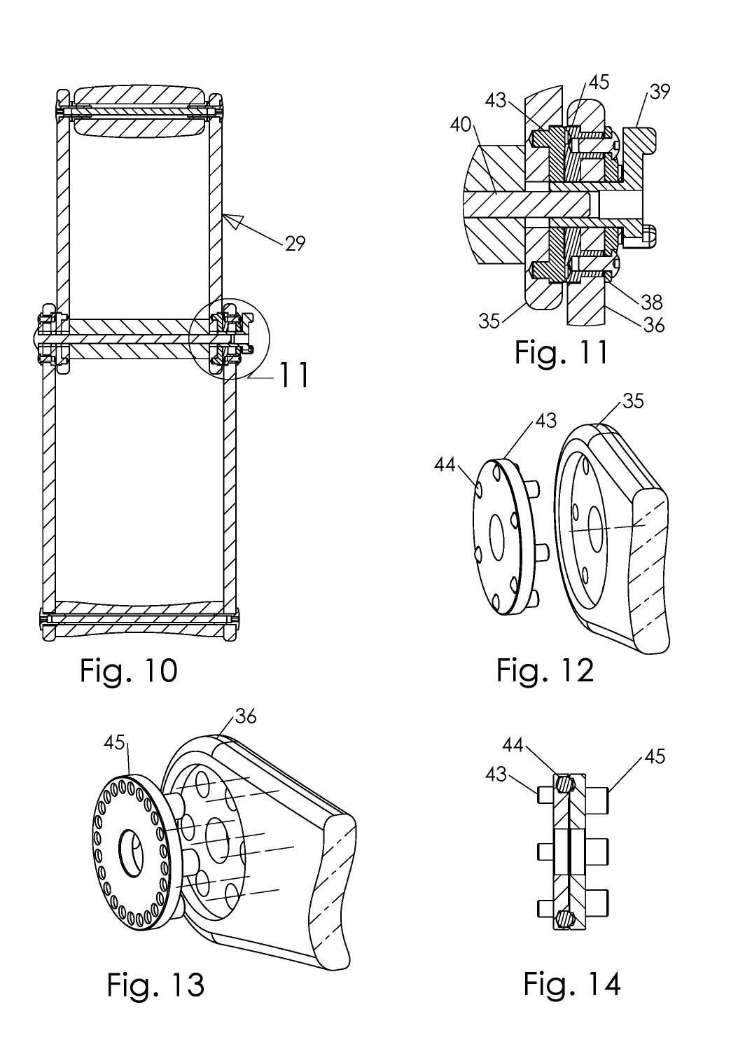

FIG. 12 shows the relationship of the inner coupling 43 to the inner side plate 35. FIG. 13 shows the relationship of the outer coupling 45 to the outer side plate 36. FIG. 14 shows a section view of the inner coupling 43 mated to the outer coupling 45 and being locked in place by ball 44 bearing against the shallow drilled hole in the face of outer coupling. FIG. 15 shows the second embodiment as it might be adjusted to allow massage of body areas that are not accessible by the first embodiment. FIG. 16 shows that the assembly of the second embodiment can be folded over into itself for compact storage and transport.

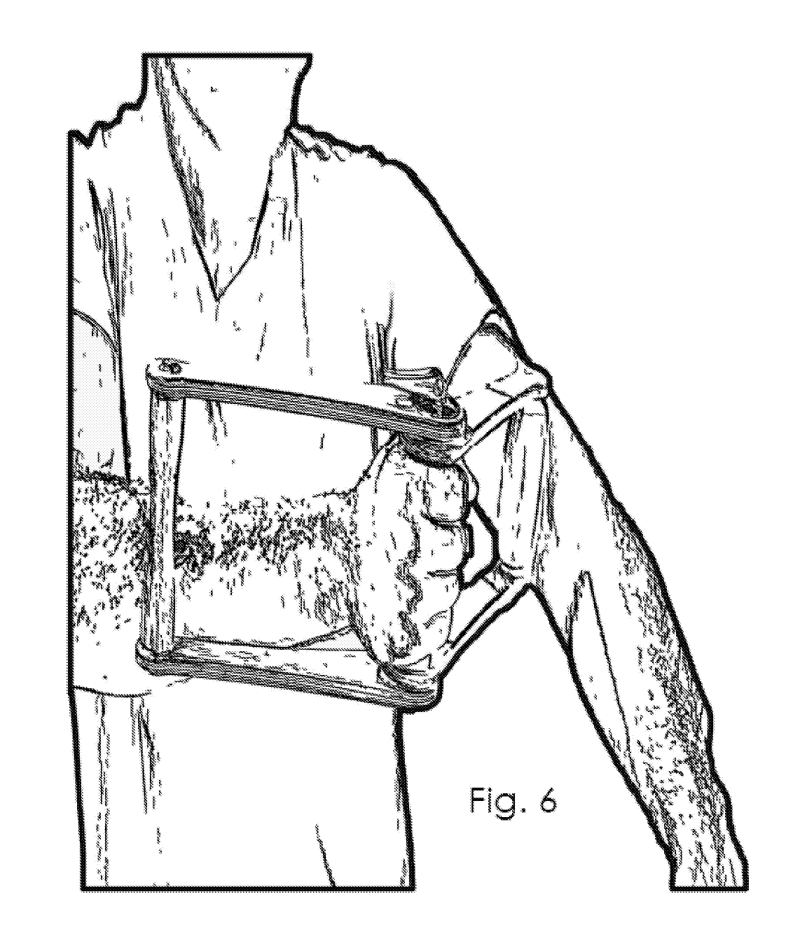

### Operational Description—FIGS. 6, 15, and 16—Second Embodiment

FIG. 15 shows the assembly of the second embodiment adjusted in an angle that is effective for massaging certain areas of the body that are not accessible with the simpler first embodiment assembly. FIG. 16 shows the neatly folded assembly that is compact and easily stored. FIG. 6 shows a person using the assembly of the second embodiment in an angled orientation to facilitate massage of the upper arm area. The operation of the assembly of the second embodiment is the same as that for the assembly of the first embodiment. The difference is that using an angled orientation allows for massage of more areas of the body that afforded by the assembly of the first embodiment.

I claim:

1. A first embodiment of a device for massaging muscles comprising a structural framework, handle, arm rest, and roller.

2. The device of claim 1 is constructed of materials including wood, plastic, and metal.

3. The device of claim 1 comprises two rigid side plates as structural framework.

4. The roller of claim 1 is mounted to one end of said device, between said side plates and is free to rotate about its axis.

5. The arm rest of claim 1 is rigidly mounted to other end of said device, between said side plates.

6. The handle of claim 1 is rigidly mounted between said side plates of said device.

7. A second embodiment of a device for massaging muscles comprising two structural frameworks, a handle, arm rest, roller, and indexable locking rotational couplings.

8. The first structural framework of claim 7 containing said roller and handle, the second structural framework containing said arm rest.

9. First and second structural frameworks of claim 7 are pivotally connected coaxially with the handle.

10. Said second structural framework of claim 7 comprises axial clamping device to effect locking of said couplings.

11. Said first and second structural frameworks of claim 7 are pivotally adjustable and lockable by said axial clamping device.
